(19) United States
(12) Patent Application Publication
(10) Pub. No.: US 2026/0369503 A1
(43) Pub. Date: Nov. 19, 2026

(54) COMPACT ELECTRICAL CONTACTOR HAVING LOW CONTACT RESISTANCE

(71) Applicant: Sonceboz Automotive S.A., Sonceboz-Sombeval (CH)

(72) Inventors: Mathieu Watrin, La Chaux-de-Fonds (CH); David Ramon, Corgémont (CH); Laurent Herbein, Joncherey (FR)

(21) Appl. No.: 19/138,754

(22) PCT Filed: Dec. 15, 2023
(86) PCT No.: PCT/EP2023/086196

§ 371 Date: Jun. 13, 2025

(30) Foreign Application Priority Data
Dec. 15, 2022 (FR) 2213478

(51) Int. Cl. H01H 50/64

(52) U.S. Cl. CPC H01H 50/643

(57) ABSTRACT

A motorized contactor incudes a fixed contact and a movable contact mobilized by a carriage, and an electric motor that controls the movement of the movable contact reversibly between a position P₂ of maximum approximation, in which it establishes mechanical and electrical contact with the fixed contact, and an open position P₁, in which the contacts are most spaced apart, with a travel having a movement region, in which the movable and fixed contacts are spaced apart, and a contact region, in which one conductive surface of the movable contact is applied against a conductive surface of the fixed contact. The motor drives a mechanism with a reduction coefficient that varies as a function of the position, with a reduction coefficient C_{I} at the interface between a movement region and a contact region of the contacts, the reduction coefficient C_{I} being lower than the reduction coefficients C_{I1} and C_{I2} at the ends of the movement region and the contact region.

### CROSS-REFERENCE TO RELATED APPLICATIONS

This application is a national phase entry under 35 U.S.C. § 371 of International Patent Application PCT/EP 2023/086196, filed Dec. 15, 2023, designating the United States of America and published as International Patent Publication WO 2024/126846 A1 on Jun. 20, 2024, which claims the benefit under Article 8 of the Patent Cooperation Treaty of French Patent Application Serial No. FR 2213478, filed Dec. 15, 2022.

### TECHNICAL FIELD

The present disclosure concerns a circuit breaker consisting of a device for controlling the closing and opening of the circuit of a high-voltage power supply, in particular, an electric battery.

### BACKGROUND

Electrically powered motor vehicles require batteries with a relatively high voltage, typically 400 Volts or even 800 Volts. It is therefore essential, for safety reasons, that certain parts of the vehicle are automatically de-energized, for example, in the event of an accident, prolonged standstill or when opening the hood, to avoid the risk of accidents to users.

Typically, solenoid relays, which are expensive and relatively heavy, are used for such cut-offs.

Circuit-breaker-like electrical switches have also been proposed, wherein a contact strip is moved by an electromechanical actuator between a closed position, where it ensures electrical continuity between two contact studs, and an open position, where these two studs are electrically isolated.

Such electrical circuit-breakers must not only ensure contact with very low electrical resistance, but also be resilient to the arcing that can occur when contact is not yet perfectly established. Various solutions for extinguishing arcs or preventing their formation have been proposed in the prior art.

In the state of the art, U.S. Pat. No. 9,859,078B2 is known describing an electromagnetic relay comprising a contact plate formed by a single continuous metal part, which has a first portion having a first thickness and a second portion having a second thickness thinner than the first thickness. This relay extinguishes the arc formed during a discharge by applying a magnetic field to the fixed contact points and to the movable contact points b laterally in both directions to generate the Lorenz force. This solution is not very satisfactory, as it requires additional, complexly controlled electromagnetic components to perform the function of preventing the formation of discharge arcs.

A similar solution using Lorentz forces is proposed by U.S. Pat. Nos. 8,514,037 or 9,336,965.

U.S. Pat. No. 10,777,374 offers a switching device comprising a first circuit breaker mechanism in a current output path from a DC power supply and a second circuit breaker mechanism in parallel with the first circuit breaker mechanism in the current output path from the DC power supply, and is connected before the first circuit breaker mechanism when output current from the DC power supply is supplied, and is disconnected after the first circuit breaker mechanism when current output from the DC power supply is interrupted. To prevent arcing, this solution proposes to include a capacitor between the DC power supply and the second circuit breaker mechanism, and a discharge unit connected in parallel with the capacitor to discharge a charge stored in the capacitor when the output current of the DC power supply is interrupted. This solution also involves adding additional bulky components to reduce arcing.

International patent application WO2006024718 proposes a device for controlling the closing and opening of the circuit of an electric battery, comprising a first terminal intended to be connected to the battery, a second terminal intended to be connected to electric circuits to be supplied, each terminal comprising a contact stud, a contact strip intended, on the one hand, to cooperate with the studs to ensure closing of the circuit and, on the other hand, to be moved away from them to effect opening. This contact strip is carried by a piston that can move against the action of a spring and is guided in a housing of a casing and controlled by a disk integral with a toothed wheel driven by a worm screw keyed to the output shaft of an electric motor with a reduction gear. The disc has cams arranged on a radius of the disc, one of the cams being located close to the periphery of the disc, while the second is located close to the axis of rotation of the disc.

U.S. Pat. No. 9,548,174 describes a contactor consisting of current-carrying contacts and a coupling element. The coupling element comprises conductive pads for engagement with the current-carrying contacts and a contact jumper extending between the conductive pads. An actuator assembly moves the coupling element between a closed position, wherein the conductive pads of the coupling element engage with the current-carrying contacts, and an open position, wherein the conductive pads of the coupling element are disengaged from the current-carrying contacts. Electromagnetic forces are generated between the contact jumper and the conductive pads to resist the electromagnetic repulsion forces generated between the current-carrying contacts and the conductive pads when the actuator assembly approaches or is in the closed position.

European patent EP1680793B1 describes an alternative solution for controlling the switching off and closing of the circuit of an electric battery, characterized in that it comprises terminals connected to studs, a contact bar carried by a piston movable against the action of a spring, an electric motor with a gearbox kinematically connected to the piston, means for controlling the motor in one direction of rotation and in the opposite direction, rotation in one direction controlling contact of the bar against the studs and rotation in the opposite direction moving the bar away from the studs.

Patent application WO2006024718 describes another solution for an electric battery cut-off and circuit-closing device, wherein a geared motor controls the displacement of a piston terminated by a contact strip, applied by a spring to a shoulder of the piston. This spring tends to keep the contact strip at a distance from two studs designed to cooperate to close the circuit. However, this solution does not solve the problem of arcing and even increases it, as arcing can occur at both ends of the strip.

Most prior art solutions are unable to combine good dynamics in the contact approach phase with high contact force without involving complex, heavy mechanisms.

Double-contact solutions are not totally satisfactory, because in reality, the contact is rarely of the congruent surface type, due to manufacturing tolerances and local deformations resulting from wear, which mean that the contact surface is often smaller than expected and gives rise to a higher electrical resistance than anticipated. The use of a solenoid-type actuator, as is very common in the prior art, generates a limited force at the contact, which makes it impossible to achieve very low contact resistance when space and mass are a predominant issue.

By way of example, an electrical contactor with double contact and associated solenoid actuator results in a relatively high contact resistance, which therefore limits the contactor's ability to carry high currents (a usual contact resistance of 300 μΩ represents a loss of 18.75 W at 250 A).

### BRIEF SUMMARY

The present disclosure aims to overcome the drawbacks of the prior art and proposes in its most general sense a motorized contactor.

A contactor according to the disclosure comprises, in particular, a fixed contact and a movable contact mobilized by a carriage, as well as an electric motor, which controls the movement of the movable contact reversibly between a position P₂ of maximum approximation wherein it establishes mechanical and electrical contact with the fixed contact, and an open position P₁ wherein the contacts are most spaced apart, with a travel having a movement region, wherein the moveable and fixed contacts are spaced apart, and a contact region wherein one conductive surface of the movable contact is applied against a conductive surface of the fixed contact, characterized in that the electric motor drives a mechanism with a reduction coefficient that varies as a function of the position, with a reduction coefficient C_{I} at the interface between a movement region (1) and a contact region of the contacts, the reduction coefficient C_{I} being lower than the reduction coefficients C_{I1} and C_{I2} at the ends of the movement region (1) and the contact region.

According to variants, the contactor also has the following features, alone or in combination:
the electric motor is connected to the carriage supporting the movable contact by a direct push-pull drive means.
the movable contact is formed by the end of an electrically conductive flexible busbar
the movable contact is moved by way of a rotatable carriage, the carriage being connected at one end to the movable contact and being articulated with respect to a pivot located at its other end, the flexible bus bar having a second end attached to the contactor housing, to form an electrical connection terminal, and in that the position-dependent reduction coefficient mechanism is coupled to the mobile carriage
the movable contact is moved by a linear motion carriage
the motorized contactor comprises a thrust spring interposed between the carriage and the movable contact
the movable contact supports a conductive pad cooperating with a conductive pad supported by the fixed contact
the movable contact is provided with two tongues respectively supporting a conductive pad and a sacrificial pad
the contactor includes an electronic circuit for controlling the electric motor
the movement regions are extended by a parking region
the contact regions include a parking region
the mechanism with a variable reduction coefficient is produced by way of a motion reducer, the last movable part of which is provided with a cam, the cam cooperating with a direct drive means integral with the carriage
the cam is provided with two cam profiles, the cam profile cooperating with a leg of the direct drive means to mobilize the carriage in one direction of rotation of the movable part, the cam profile cooperating with a second leg of the direct drive means to mobilize the carriage in the other direction of rotation of the movable part
the cam and each of the legs have complementary means for ensuring a stop delimiting the travel of the movable part in each of the directions of rotation
the electronic circuit includes a position sensor, measuring the position of the carriage
the position sensor is a two-state sensor consisting of two flexible, electrically conductive blades and means for measuring the electrical resistance between the blades located on the electronic board, the changeover between two states being discriminated by measuring the electrical resistivity between the blades and being obtained for a given relative position between the carriage and the electronic board.

The disclosure also relates to a mechatronic electrical connection assembly provided with a housing containing a motorized contactor as described herein.

In a particular embodiment, the housing includes an electronic board with means for controlling the two motorized contactors.

Optionally, the housing comprises a second fixed contact and a second movable contact also mobilized by the electric motor.

### BRIEF DESCRIPTION OF THE DRAWINGS

The present disclosure will be described in more detail with reference to non-limiting example embodiments specifying the aforementioned advantages and considerations.

FIG. 1 shows a perspective view, with the cover removed and the housing in partial section, of an example of a motorized contactor according to the disclosure;

FIG. 2 shows an exploded view of a first embodiment;

FIG. 3 shows a view of the cover of a first embodiment;

FIG. 4 shows an axial view of the stator assembly molded into the housing and equipped with its electronic board;

FIG. 5 shows a cross-sectional view in the plane containing the axes of the gearbox of the first embodiment;

FIG. 6 shows a cross-sectional view of the first embodiment, equipped with a direct push-pull drive, and shown at the end of the travel region;

FIG. 7 shows a cross-sectional view of the first embodiment, equipped with a direct push-pull drive, and shown at the interface between the travel region and the contact region;

FIG. 8 shows a cross-sectional view of the first embodiment, equipped with a direct push-pull drive, and shown at the end of the contact region;

FIG. 9 shows a schematic depiction of the angular position, angular speed and force of the mobile carriage over its entire travel;

FIG. 10 shows a cross-sectional view without the housing of a second embodiment;

FIG. 11 shows a perspective view, with the cover removed and the housing in partial cross-section, of a variant embodiment of a motorized contactor according to the disclosure;

FIG. 12 shows an exploded view of the carriage and cam-supporting movable part of the variant shown in the previous figure;

FIG. 13 shows a detailed view of the cam of the variant shown in FIG. 11;

FIG. 14 shows a cross-sectional view of the variant embodiment with a direct push-pull drive and shown at the end of the movement region;

FIG. 15 shows a cross-sectional view of the variant embodiment with a direct push-pull drive, and shown at the interface of the movement region and the contact region;

FIG. 16 shows a cross-sectional view of the variant embodiment with a direct push-pull drive, and shown at the end of the contact region;

FIG. 17 shows a partial cross-sectional view without housing of a variant embodiment with auxiliary contacts;

FIG. 18 shows a detailed cross-sectional view of the variant embodiment shown in the previous figure;

FIG. 19 shows a variant embodiment of auxiliary contacts;

FIG. 20 shows a variant embodiment with two contactors in a single housing;

FIG. 21 shows a variant embodiment with two contactors in a single housing, sharing the same motorization;

FIG. 22 shows a variant embodiment with two contactors in a single housing, sharing the same motorization and same reduction; and

FIG. 23 depicts a view, cover removed, of a variant embodiment of a motorized contactor according to the disclosure.

### DETAILED DESCRIPTION

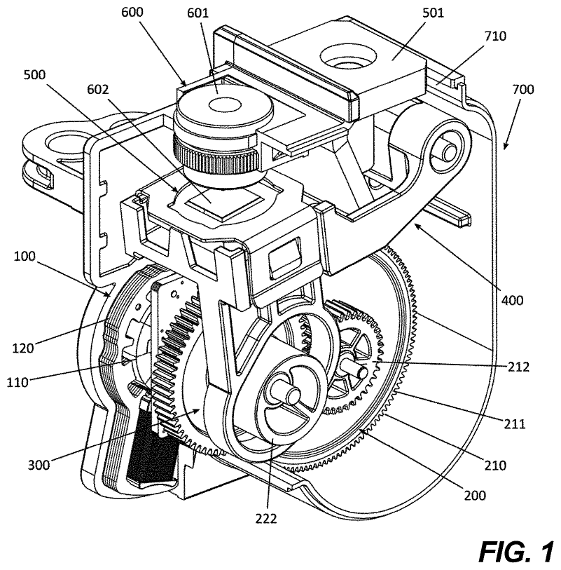

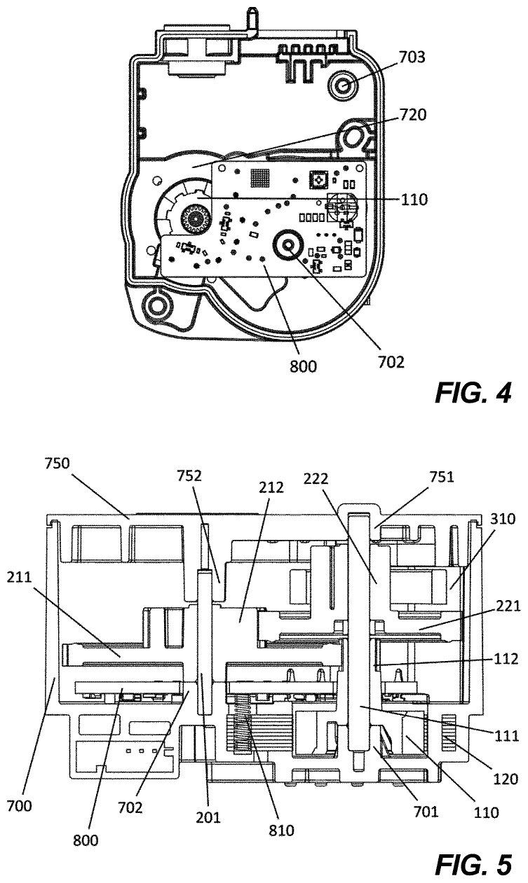

The contactor described with reference to the accompanying FIGS. 1 to 10 includes a housing (700) made of an electrically insulating material. This housing (700) has on its inner surface receiving regions (701, 702) for the shaft (111) of the rotor (110) of the electric motor (100) and the shaft (201) of a reduction stage of the gearbox (200). A further receiving region (703) is designed to receive a guide bearing for the pivot pin (410) of the carriage (400) supporting the movable contact part (500). This housing (700) with its receiving regions (701, 702, 703) is advantageously produced by molding a plastic material.

The housing (700) is closed by a cover plate (750), which has shaft-receiving regions (751, 752, 753) on its inner surface, as well as stops limiting the travel of the cam (222). Advantageously, the stops are made by pressing the cam (222) on the same fixed plane (760) of the cover plate (750) to allow a 180° travel between these two stops.

A connection terminal (601) is molded onto one side of the housing (700). In the exemplary embodiment described, the fixed contact (600) is a silver alloy pad (602), or more generally a pad made of a material with good electrical conductivity, soldered to the inner surface of the connection terminal (601). An electrical connection cable can be connected to this terminal (601) in a known way.

The housing (700) also features an opening (710) for the passage of an electrical terminal (501) connected to the movable contact supported by the mobile carriage (400). This second electrical terminal (501) is also designed for connecting an electrical cable.

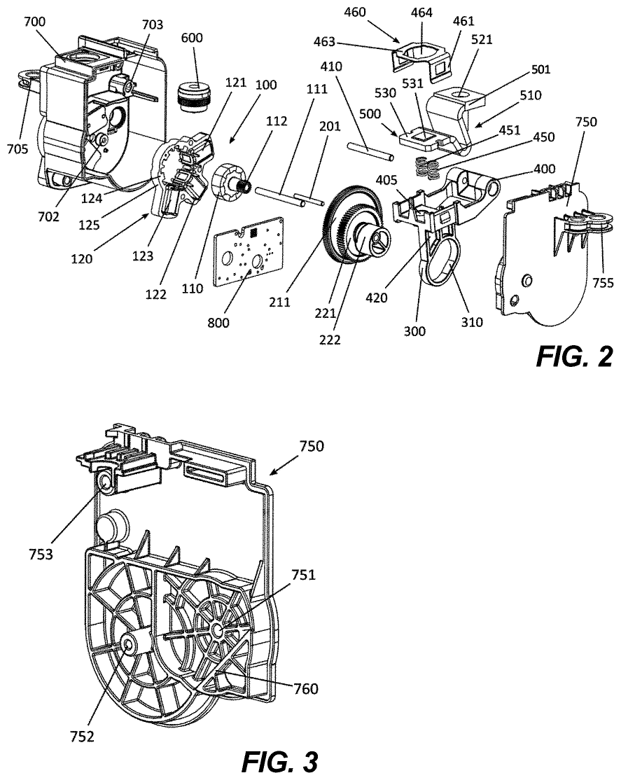

As shown in FIGS. 2 and 3, the electric motor (100) comprises a stator (120) formed by a stack of laminations cut to have three wound projections (121, 122, 123) and unwound projections (124) extending radially from a peripheral yoke (125). This stator (120) including the coils (130 (not shown)) is held in the bottom of the housing (700) by an overmolded assembly (720).

In the example described, the stator (120) is asymmetrical, enabling it to be positioned at an angle to the housing (700) and freeing up space for positioning the gearbox (200).

This gearbox (200), particularly visible in FIG. 5, comprises two reduction stages created by the association of the rotor and two movable parts (210, 220): the first stage is driven by the pinion (112) linked to the rotor (110), the latter being free to rotate with respect to the fixed shaft (111).

This pinion (112) drives a gear (211) to form the first reduction stage. The gear (211) is linked to a pinion (212) to form a first movable part (210) driving a second gear (221) linked to an eccentric protrusion forming a cam (222). The association between the second gear (221) and the cam (222) forms a second movable part (220) guided by the rotor axis (111) offset from the center of the cam (222).

Typically, the reduction ratio between rotor and cam is 12:1, and preferably between 4:1 and 30:1.

In the variant shown in FIG. 2, the housing (700) and its cover plate (750) are fitted with mounting lugs (705, 755) to secure the contactor to its application, in addition to the connection terminals (501, 601) providing both the electrical and mechanical connection to the application. Nevertheless, given the low weight of the actuator, the skilled person could consider removing the lugs (705, 755), leaving the connection terminals (501, 601) to bear the full mechanical stress.

### ELECTRIC MOTOR CONTROL (100)

The electric motor (100) is a permanent magnet motor controlled by an electronic circuit (800) integrated in the housing of the electric motor (100). This electronic circuit (800) includes a conductive track connected to the ground pin of the housing connector (700) on the one hand, and on the other hand, coming into contact with the end of a spring (810), visible in FIG. 5, passing through a bore made in the stator yoke of the motor. When the electronic circuit is applied against this spring (810), it compresses the spring, whose coils deform laterally and come into contact with the inner surface of the hole, allowing the stator yoke to be at the same electrical potential as the connector's ground pin.

### DIRECT DRIVE OF THE CARRIAGE (400) CARRYING THE MOVABLE CONTACT (500)

The role of this geared motor is to control the movement of the carriage (400) carrying the movable contact (500) between a position where this movable contact (500) is spaced apart from the fixed contact (600), and a position where this movable contact (500) is applied against the fixed contact (600), with a first rapid movement with low torque in a so-called approach region, followed by a movement with low speed and high torque in a so-called contact region.

The aim is to ensure a short reaction time when the contactor is activated, and above all to reduce the time during which the contact parts are close enough to trigger an arc.

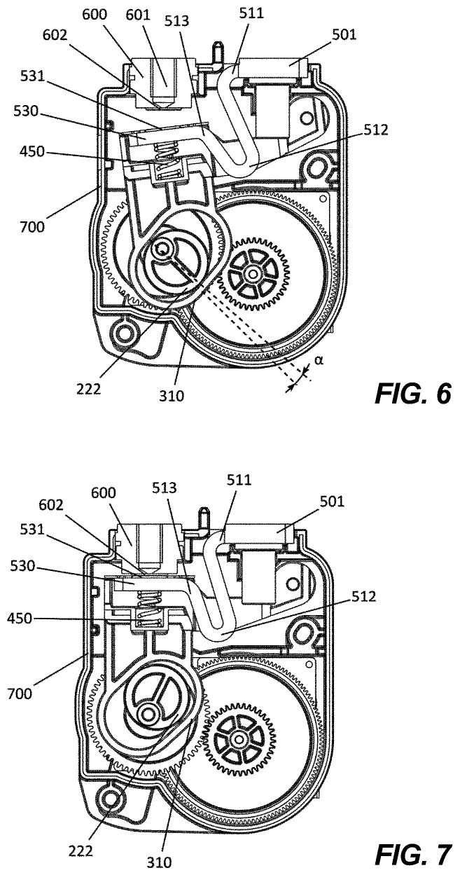

This aim is achieved, in the example described, by a direct, push-pull drive means shown in FIGS. 6 to 8 respectively at the end of the movement region, at the interface of the movement region and the contact region, and at the end of the contact region.

This direct drive means (300) has an oblong slot (310) defining a cam track within which the cam (222) is engaged, to control a constrained movement, transforming the rotary movement of the cam (222) into a movement along an arcuate trajectory of the carriage (400), which is connected to the housing (700) by a pivot connection, guided by way of a pin (410) inserted into a receiving area (703, 753) of the housing (700) and cover plate (750). The whole assembly forms a disc cam with an internal profile.

The oblong slot (310) has, for example, a shape determined by two rectilinear segments connected by arcs of circles, of the rectangular type with rounded corners, the lateral sides typically being semicircles, the width of the slot being slightly greater than the diameter of the cam (222). As the cam (222) traverses the edge of the oblong slot (310), it controls a movement with a continuously variable transmission ratio as a function of the position of the cam (222) relative to the oblong slot (310).

In contactor versions based on direct drive of the carriage by the drive means, “direct drive” means that the position of the carriage is directly and solely linked to the angular position of the drive means (in the example described, the cam), in all positions, to within manufacturing tolerances. In any position, the carriage has no freedom of movement relative to the direct drive (300), apart from the clearance resulting from manufacturing tolerances. This definition is to be contrasted with a drive wherein the carriage has movement phases wherein it is moved by a means additional to the carriage, such as a spring.

The movement of the carriage (400) is a rotation over an angular sector, commanding the end supporting the movable contact (500) to follow an arcuate trajectory between an extreme position where the movable contact (500) is furthest from the fixed contact (600), and an angular region where the surface of the movable contact (500) is applied against the surface of the fixed contact (600).

It should be noted that the mobile carriage (400) can be rotatably guided by way of a pin (410) mounted in a fixed position relative to the carriage and rotatably guided by the receiving region (703), but other solutions can be envisaged by those skilled in the art. For example, guidance could be provided by plastic protrusions on the moving carriage (400), directly inserted into the receiving regions (703, 753) of the housing (700) and cover plate (750).

### MOVABLE CONTACT (500)

The movable contact (500), particularly visible in the exploded view in FIG. 2, is supported by the mobile carriage (400) via thrust springs (450, 451) arranged between the rear surface of the movable contact (500) and the carriage (400) housing wherein the movable contact (500) is positioned.

The carriage (400) includes a guide part, which is guided at its rear on a pivot pin (410) inserted into a receiving region of the housing (700). It is formed by a rigid insulating body to enable high pressure to be exerted on the front end containing the electrical contact (500). Its front part, opposite the pin (410), is extended by a lug (420) wherein the oblong slot (310) is cut, the perforated end of this lug (420) forming the direct drive means (300).

In one embodiment, the movable contact (500) is a flexible busbar (510).

This flexible busbar (510) can be formed by a stack of copper foils welded together only at their ends, or by one or more braided layers of copper wire or a similar electrical conductor, or by any other reversibly deformable conductive connection.

This flexible busbar (510) is attached to the housing (700) to pass through the opening (710) directly above the rear of the carriage (400), to allow the carriage (400) to pivot without dragging this rear part of the flexible busbar (510). The rear connection terminal (501) of the flexible busbar (510) has a bore (521) to accommodate a threaded insert for attaching a connection cable making electrical contact with the upper part of the connection terminal (501) at the rear of the flexible busbar (510).

The flexible busbar (510) features alternating curvatures (511, 512, 513) configured to allow deformation of the bar, with stress distribution between the upper and lower leaves being substantially identical.

The movable contact (500) can be realized in a way other than by a flexible busbar (510), for example, by two conductive parts joined together by a flexible connection.

The front contact region (530) of the movable contact (500) has an upper surface facing the lower surface of the fixed contact (600), so that when the carriage (400) is in the contact position, this contact region (530), preferably provided with a conductive pad (531), is applied congruently against the lower surface of the fixed contact (600), which is also preferably provided with a conductive pad (602). The opposite surface comes to rest against the carriage surface (400) either directly or via one or more thrust springs (450). Typically, the travel of this spring (450) is a few millimeters, typically 1 to 4 mm, after preloading.

A metal rider (460) having a folded sheet to form two side tabs (461) connecting a top face (463) is clipped onto the side faces of the front end of the carriage (400). It closes the housing of the front contact region (530) of the movable contact (500) with an upper face (463) wherein an opening (464) is cut for the pad (531) to pass through. This rider (460) holds the front contact (530) in the front end of the carriage (400), under stress from the spring (450), which pushes it back against the top face (463).

The bottom of the front end of the carriage (400) has one or more cavities (405) wherein the rear end of the spring or springs (450) is engaged.

### KINEMATICS

When the contactor is in the “open” position, cutting off current flow between the two cables connected to the terminals (501, 601), the carriage (400) is in the position where its front end is furthest from the fixed contact (600), with an air gap between the pad (531) of the movable contact (500) and the pad (602) of the fixed contact (600).

Conversely, when the contactor is in the “closed” position, the carriage (400) is in the position where its front end presses the pad (531) of the movable contact (500) against the pad (602) of the fixed contact (600).

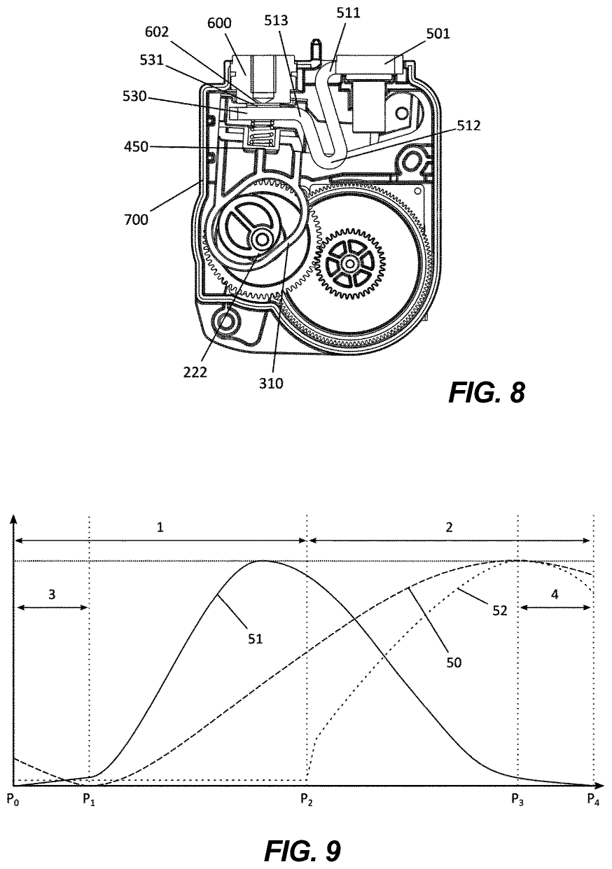

FIG. 9 illustrates the kinematics of the contactor, and more particularly:
the curve (50) shows the angular position of the mobile carriage (400) as a function of the angular position of the cam (222),
the curve (51) represents the evolution of the angular speed of the mobile carriage (400) as a function of the angular position of the cam (222)
the curve (52) shows the evolution of the force applied by the movable contact (500) on the fixed contact (600) as a function of the angular position of the cam (222).

The pivoting of the mobile carriage (400) first sweeps a movement region and then a contact region.

In the movement region (1), the cam (222) causes the mobile carriage (400) to swivel in an accelerating movement, with low torque, due to a low reduction ratio in order to reach maximum speed on approaching the contact region.

The movement region (1) refers to the stroke during which the mobile carriage (400) brings the movable contact (500) closer to the fixed contact (600), or moves them apart, but where the two movable (500) and fixed (600) contacts are not yet in contact.

This movement region (1) can be preceded by a parking region (3) where the forces exerted on the mobile carriage (400) irreversibly pull it against its rear stop in the absence of power from the electric motor (100).

The contact region (2) corresponds to the part of the stroke of the mobile carriage (400) covered after the contact surface (530), and where applicable the upper surface of the conductive pad (531), is applied against the lower surface of the fixed contact (600). In this contact region (2), the cam (222) continues to cause the mobile carriage (400) to pivot in a slowing motion, with a higher torque than in the approach region in order to compress the spring(s) (450) and reach zero speed at the end of the contact region (2).

The contact region (2) can include a second parking region (4).

To close the contact, the electric motor (100) is rotated, which drives the gearbox (200) and the drive means (300), causing the mobile carriage (400) to pivot first out of the parking region (3), between a position Po where the carriage (400) is in “open” abutment, and a point of no-return P₁, then into the movement region (1), to a point P₂ where the upper surface of the conductive pad (531) is applied against the lower surface of the fixed contact (600), establishing electrical and mechanical contact.

The carriage (400) then continues to pivot in the contact region (2), first between point P₂ and point P₃ where the contact force is at its maximum, and finally in a second parking region (4) until the cam (222) comes to rest at point P₄. Point P₃ is also a point of no return.

The parking regions (3, 4) are areas where the cam (222) is immobilized against respective stops in the absence of power to the electric motor (100).

### TWO-CONTACT VARIANT

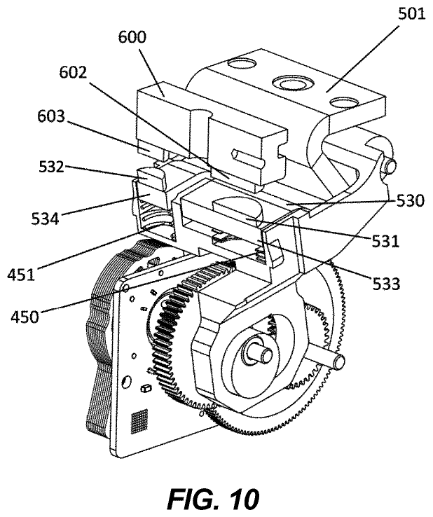

In one variant, shown in FIG. 10, the contactor can control the opening and closing of two (or more) power contacts simultaneously or with a slight offset.

In this case, the housing is fitted with a single fixed contact with two contact pads soldered to a conductor common to two movable contacts, or with two fixed contacts (600). The mobile carriage (400) has two movable contacts (500) arranged in parallel.

To this end, one of the contacts provides good resistance to arcing, but lower electrical conductivity, and features a sacrificial pad.

The other contact provides good electrical conductivity, but less resistance to arcing, and features a pad made of a material that is a good electrical conductor.

The first contact to ensure arc-resistance closes first and opens last.

For this purpose, one of the embodiments shown in FIG. 10 is to provide a busbar (510) slotted at its end at the front contact (530) to form two parallel tongues (534, 533), one supporting a sacrificial pad (532) and the other a good-conducting pad (531).

The tongue (534) supporting the sacrificial pad (532) is preloaded by a spring (451) that is less stiff than the spring (450) provided for the other tongue (533), so that the sacrificial pad (532) is closer to the sacrificial pad (603) on the surface of the fixed contact (600) than the good-conducting pad (531) is to the good-conducting pad (602) on the surface of the fixed contact (600), so as to ensure closure of the electrical circuit before the good-conducting pads (531, 602) enter the arcing region in the movement region (1).

### DIRECT DRIVE VARIANT EMBODIMENT

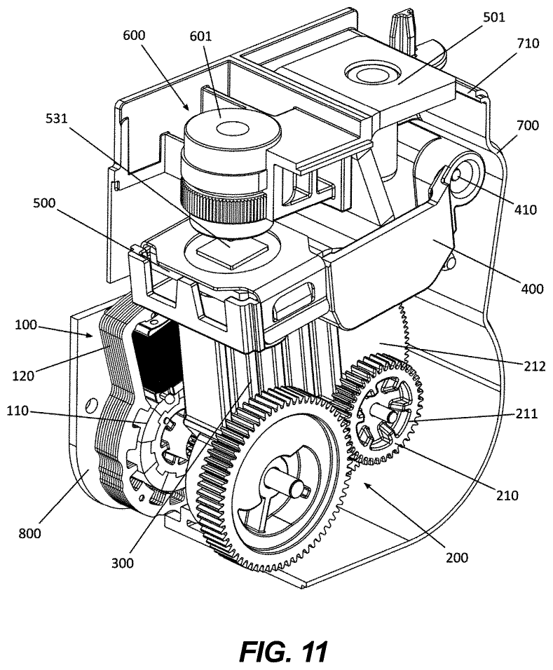

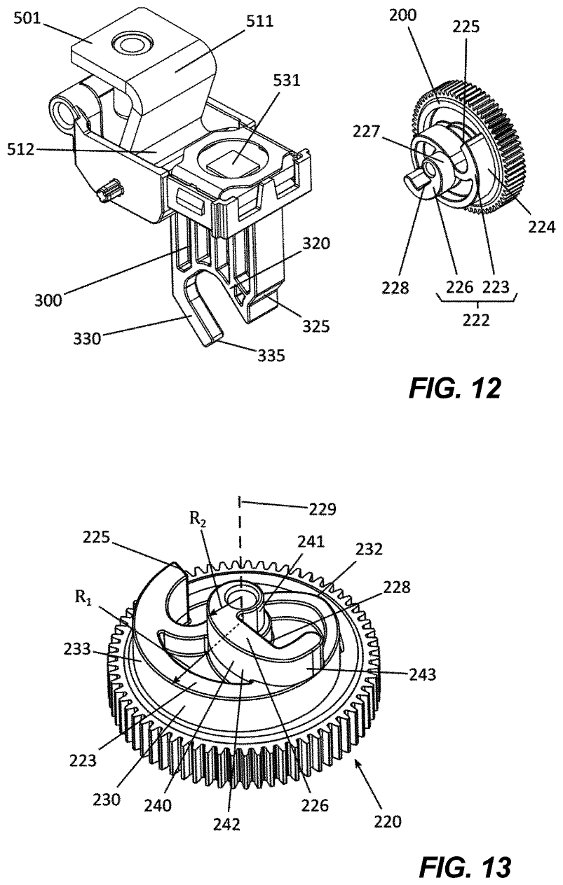

A variant embodiment of the direct drive means (300) is shown in FIGS. 11 to 16. This embodiment differs from the one shown in FIGS. 1, 2 to 6, 7, and 8 in that the oblong slot (310) is open to form a “C,” this shape being achieved by way of two legs (320, 330) extending the body of the direct drive means (300). This embodiment also differs in that the cam (222) has two protrusions (223, 226) in successive axial extension of the movable part (220), as can be seen in FIGS. 12 and 13, FIG. 12 representing an exploded view of the movable part (220) and the carriage (400) with which it cooperates via the direct drive means (300), and FIG. 13 representing a detail view of the movable part (220). The protrusions (223, 226) therefore cooperate respectively with each of the legs (320, 330), one of the protrusions (223, 226) ensuring movement of the direct drive means (300) during clockwise rotation of the cam (222), the other ensuring movement during counterclockwise rotation.

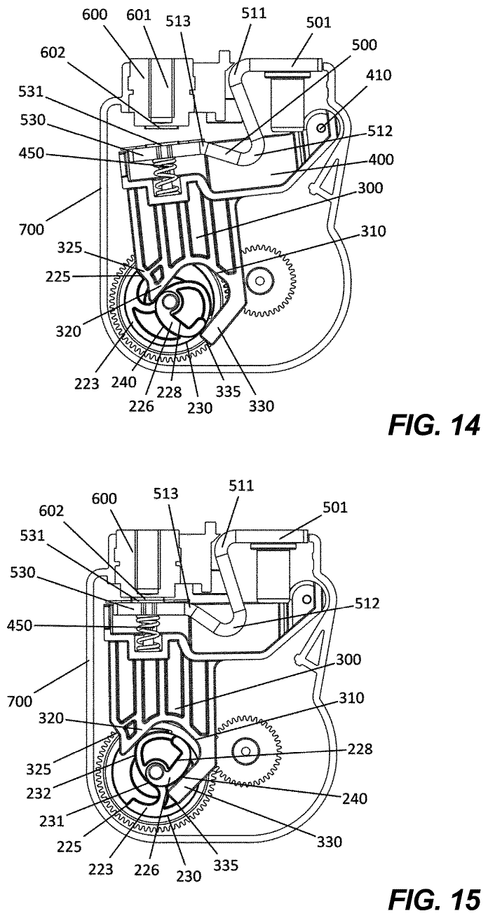

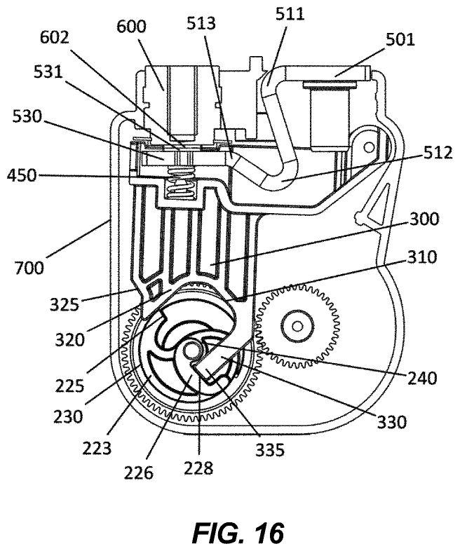

FIGS. 14 to 16 show successive stages in the movement of the direct drive means (300) when the contact is closed by counterclockwise rotation of the cam (222). When the cam (222) is rotated counter-clockwise, the cam profile (224) of the protrusion (223) comes into contact with the leg (320) and causes the carriage (400), mechanically linked to the direct drive means (300), to rotate about its pin (410). FIG. 14 shows the state wherein the contact is completely open, FIG. 15 shows the state corresponding to the electrical contact between the pads (602, 531) of the fixed contact (600) and the movable contact (500), and FIG. 16 shows the state of complete contact closure, wherein the force exerted between the fixed contact (600) and the movable contact (500) is at a maximum, so as to obtain the lowest possible contact resistance. The final closed position, shown in FIG. 16, is achieved by abutting one side (228) of the protrusion (226) against the end (335) of the leg (330).

From the state shown in FIG. 16, the contact is opened by clockwise rotation of the cam (222). The cam profile (227) of the protrusion (226) then comes to rest on the leg (330) and causes the carriage (400), mechanically linked to the direct drive means (300), to rotate about its pin (410). The final open position, shown in FIG. 14, is obtained by abutting one end (225) of the protrusion (226) against one side (325) of the leg (320).

Although two different cam profiles (224, 227) are used to open and close the contact, carriage movement is always ensured by the cooperation of the cam (222) and the direct drive means (300). The use of two cam profiles (224, 227) advantageously makes it possible to benefit from a stroke close to 360° to ensure contact opening or closing and, therefore, to obtain better control of displacement, with regard to manufacturing precision, as well as to reduce the reduction coefficient required to obtain the same angular travel of the carriage from the rotation of the movable part (220). As in the first embodiment, it is necessary to provide a high reduction ratio at the start and end of travel, so as to obtain irreversible equilibrium positions in the absence of motor power, but also to minimize contact resistance in the closed position, but it is also necessary to maximize opening and closing speed to improve actuator responsiveness and reduce arcing problems. To this end, the cam tracks (230, 240), characterized by the evolution of their distances R₁ and R₂ from the axis of rotation (229) of the movable part (220), have a first region (231, 241) wherein the distances R₁ and R₂ start at a minimum and increase only slightly, followed by a second region (232, 242) wherein the distances R₁ and R₂ increase rapidly, and followed by a final region (233, 243) wherein the distances R₁ and R₂ are almost maximal and increase slightly up to this maximum.

It may be noted that the cam tracks (230, 240) can only move the direct drive means (300) when rotation of the movable part (222) leads to an increase in the distance R₁ or R₂ of the point of contact on this cam track (230, 240) between the protrusion (223, 226) and the associated leg (320, 330). In this way, one cam track (240) increases for clockwise rotation of the movable part (220), while the other cam track (230) increases for counterclockwise rotation of the movable part (220).

In the examples described above, the direct drive means (300) is provided by a cam. Of course, this means can be provided by an equivalent means, for example, a connecting rod, a toothed sector, or a lever.

The example below describes the movement of the mobile carriage with a pivoting movement. Of course, the displacement could also be linear.

### VARIANT WITH AUXILIARY CONTACT

The disclosure also concerns a system for detecting particular positions of the opening or closing stroke of the electric contact. For safety reasons during handling, for example, it is essential to ensure that there is galvanic isolation when the contactor is opened, and that contact is made when it is closed.

A possible means of detecting these positions is via a sensor, arranged on the electronic board (800), which switches between two voltages when a position of the contactor stroke is reached, i.e., the sensor is in the high state over a continuous portion of the stroke and in the low state over the remainder of this stroke.

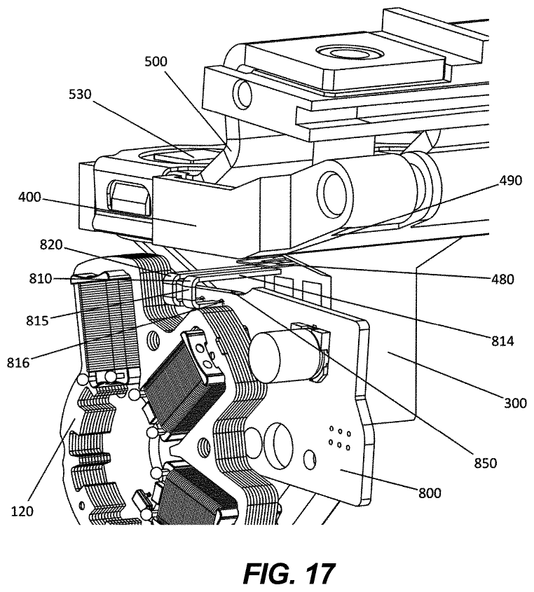

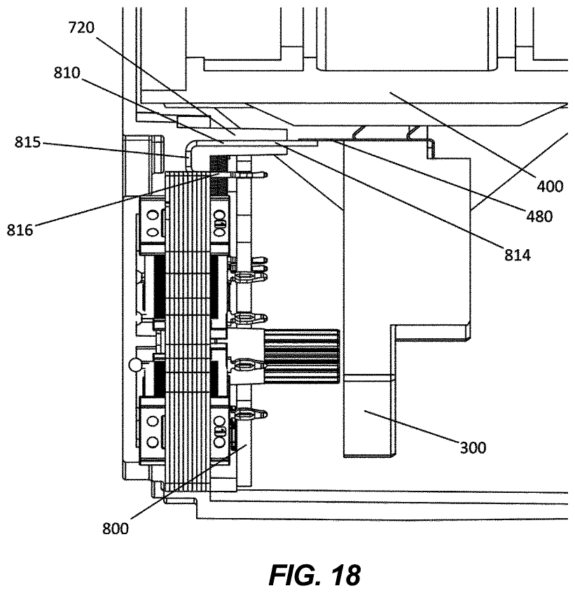

A first embodiment of this function is shown in FIGS. 17 and 18, with FIG. 17 showing a perspective view of the electronic board (800), stator and carriage (400), and FIG. 18 showing a side view of these elements, with the stator additionally overmolded in the housing (700).

The detection means consists of two parallel blades (810, 820) attached at one end to the electronic board (800) and left free at their other end. The free ends can each come into contact with a deformable blade (480, 490) attached to the carriage (400). The blades (810, 820, 480, 490) are electrically conductive and the complementary deformable blades (480, 490) attached to the carriage (400) are electrically connected, preferably by being cut from the same piece of conductive metal. The complementary deformable blades (480, 490) attached to the carriage (400) are also parallel and arranged in such a way that they simultaneously come into contact with the blades (810, 820) attached to the electronic board (800), at a position Pc, when the main contact is opened and therefore the carriage moves toward the electronic board. Thus, in position Pc, the blades (810, 820) are in electrical contact via complementary deformable blades (480, 490) attached to the carriage (400). Position Pc can therefore be detected by measuring the resistivity between the blades (810, 820). For this purpose, the ends of the blades (810, 820) attached to the electronic board (800) can be electrically connected to the appropriate components on the electronic board for this measurement.

The blades (810, 820) are “J”-shaped, with two parallel legs (814, 816) separated by an angled portion (815). One of the legs (816) is short and has the end attached to the electronic board and the other leg (814) is long and is terminated by the free end coming into contact with the complementary deformable blades (480, 490) attached to the carriage (400). In this way, the blades (810, 820) are terminated by press-fit connections for insertion into the circuit board on the side opposite the carriage (400). This enables the angled portion (815) of the blades to be overmolded directly into the housing (700), so that their positioning relative to the carriage (400) can be controlled as much as possible. The electrical terminations of the stator coils (120) are also provided with press-fit connectors extending towards the carriage (400), so that the stator and blades (810, 820) can be jointly overmolded in the housing (700) and the electronic board can be inserted in one operation onto the overmolded assembly (720) to establish all the electrical connections.

The blades (810, 820) are arranged at the edge of the electronic board (800), the latter being locally provided with a notch (850) to leave sufficient space for their overmolding. It should be noted that the overmolding of the stator (120) and blades (810, 820) is by no means restrictive of this embodiment, the aim being to index these elements correctly in relation to the housing. It could also be imagined that the housing comprises precise positioning elements and that the stator or blades are set, screwed or shrink-fit into it.

The mode of implementation providing a high state from position Pc of the opening stroke is only one particular example embodiment. It is easy to imagine configurations wherein the blades (810, 820, 480, 490) are arranged to provide a high value when a position of the closing stroke is reached, or even multiplying the number of this type of sensor to provide information on reaching multiple positions. The deformable blades could also have sufficient flexural travel to measure multiple positions during a single stroke, for example, during a contact closure stroke. It would be conceivable to have a sensor switching to the high state from the moment when the conductive pads of the fixed contact and the movable contact make electrical contact, and a second sensor switching to the high state at the end of the stroke, when the contact force is sufficient to minimize electrical resistance. Of course, in addition to the state of the sensor, it is also useful to exploit its transition from one state to another. Relevant positions to be measured also include making electrical contact with the main contactor, opening and closing end-of-travel positions, reaching a sufficient distance between the fixed contact and the movable contact to ensure sufficient dielectric strength between these components at the operating voltage, and reaching a portion of travel with a high reduction coefficient to possibly adapt the control strategy for stopping.

Lastly, the design shown suggests the use of rigid blades (810, 820) and complementary flexible blades (480, 490), but the person skilled in the art could easily imagine variants where the blades (810, 820) are flexible and come into contact with a rigid metallized part of the carriage. It could also be envisaged that all the blades (810, 820, 480, 490) are flexible. The essential prerequisite is that this auxiliary contact must be flexible enough to provide a high state over a desired range of the carriage (400) stroke, while avoiding destruction.

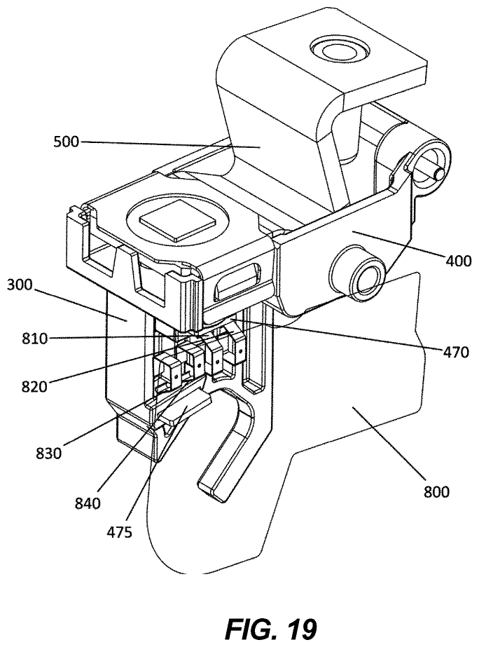

A variant of the position detection system is shown in FIG. 19, showing a perspective view of the carriage (400) and the flexible blades (810, 820) arranged on the electronic board (800), the latter being shown in transparency. This design differs from the previous design in that the flexible blades (810, 820) are integrated into an SMD-type component mounted on the electronic board of carriage (400). These flexible blades (810, 820) cooperate with a rigid metal insert (470) integral with the carriage (400), the whole being arranged to detect a position of the opening stroke.

This variant also features a second pair of flexible blades (830, 840) cooperating with a second rigid metal insert (475) integral with the carriage (400), all arranged to detect a position of the closing stroke.

Position detection is not limited to these examples, and the skilled person could easily imagine other possible variants, such as the use of a mechanical contactor arranged on the electronic board and having an arm cooperating with a stop on the carriage, or magnetic detection means, such as a Hall probe that can be arranged on the electronic board to measure the field of a magnet arranged on the carriage, or on one of the elements of the motion reducer assembly.

The position sensors can also be used to calibrate the stroke of a stepper motor. By using two sensors to detect the position of two stops, it is possible to know how many motor control steps exist between these two stops, and the position of the carriage between these two stops can be determined by counting the number of steps taken from one stop and knowing the evolution of the reduction coefficient during the carriage stroke.

The position sensors can also be used to detect, during an opening stroke, whether this process has been completed correctly, and whether the movable contact has stuck to the fixed contact. As the carriage is driven directly by the motor, contact opening can be forced by increasing the motor supply current, should the conventional opening procedure fail to lift the movable contact from the fixed contact.

### VARIANT FOR CLOSING MULTIPLE CONTACTS

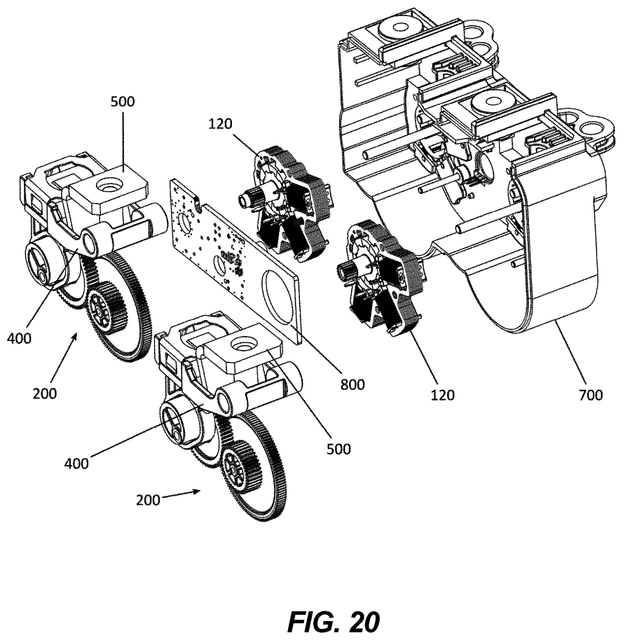

The disclosure also relates to motorized contactors for closing multiple different circuits in a variety of configurations, some of which are shown in FIGS. 20, 21 and 22. It is therefore proposed to pool a greater or lesser proportion of components to close multiple circuits, in order to meet different needs. In particular, FIG. 20 illustrates the arrangement of two contactors in the same housing (700) and sharing common electronics (800). These electronics independently control the windings of the stators (120) of two motors, which drive two gearboxes (200) moving two carriages (400) to close two independent electrical circuits. The advantage of this solution is that it offers totally independent control of the closing of the two electrical circuits, while pooling a maximum number of components.

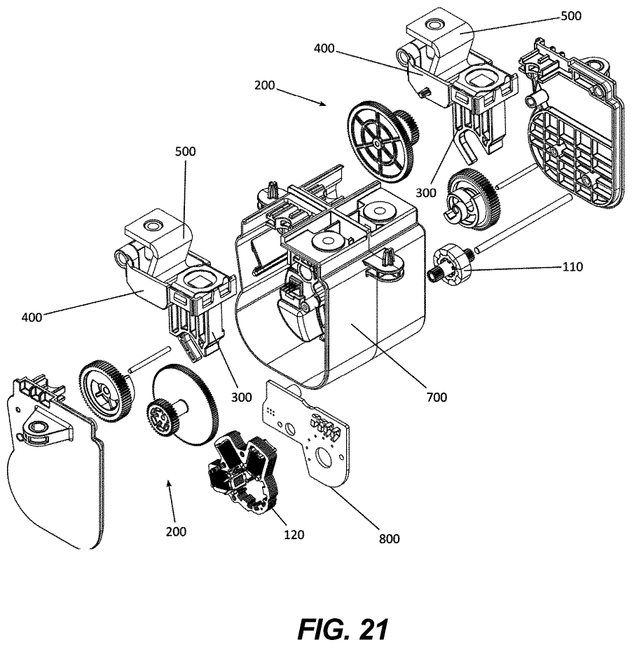

This independence of contact closure is not always necessary and, in some cases, it is useful to provide joint closure of the circuits, either synchronously or asynchronously. FIG. 21, therefore, illustrates a double contact variant wherein the housing (700), the electronic board (800) and the rotor (110) and stator (120) forming the electric motor are shared. The rotor (110) therefore drives two sets of gearboxes (200), each moving a carriage (400) to close two different contacts. This construction is advantageous for proposing different asynchronous closing strategies. For example, by selecting different cam profiles for the direct drive means (300) of each carriage (400), it is possible to close or open first one contact, and then the second.

The associated requirements may be multiple and, for example, it may be desired to start the movements of each of the carriages (400) at different times, so that the torque peaks associated with starting each motor are not synchronous. This can be achieved with one of the cams having a constant radius at the start of travel to avoid generating movement. Asynchronous closing could also be used to pause electric motor control once one of the circuits has been opened or closed, before starting or continuing the closing or opening sequence of the second.

Finally, it would also be possible to open the two circuits independently, reserving the movement of each of the carriages (400) to an angular sector of the rotation of the module. For example, the cams (222) can be specially profiled to drive the associated direct drive means (300) only through an angle of less than 180° over a full stroke. We can then imagine several scenarios and adapted cam profiles, for example, to close both contacts successively while driving the motor in the same direction, thus creating several states, one where both contacts are open, another where one contact is open and the other closed, and a final state where both contacts are closed. Another possibility would be to generate cam profiles that close the associated contact for rotation in opposite directions. There would then be an intermediate position in the full rotation stroke where both contacts are open and, from this position, rotation in one direction would close only one contact and rotation in the other direction would close only the other contact.

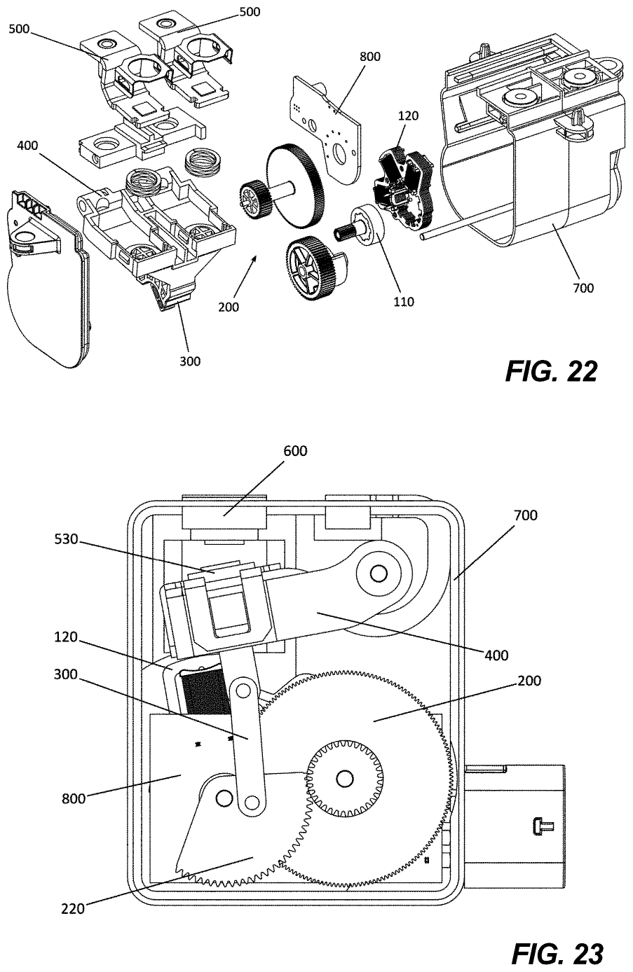

Finally, FIG. 22 shows the pooling of all components except the fixed contacts (630) and the movable contacts (500). In contrast to the embodiment shown in FIG. 10, this configuration enables two electrical circuits to be closed, which may be independent of one another, but from the same control command. It is also possible to close the circuits synchronously or asynchronously, by choosing different distances between the fixed and movable contacts for the two circuits.

### DIRECT DRIVE VARIANT

A variant of the direct drive means (300) is shown in FIG. 23. This embodiment differs from preceding embodiments in that the direct drive means (300) is a connecting rod fixed with one degree of freedom in rotation, for one end on the last movable part (220) eccentrically with respect to the axis of rotation of the movable part (220) and for the other end on the carriage (400), so as to provide a variable reduction ratio between the electric motor (100) and the carriage (400).

1. A motorized contactor, comprising:
a fixed contact;
a movable contact mobilized by a carriage;
an electric motor configured to control movement of the movable contact reversibly between a position P₂ of maximum approximation, wherein the movable contact establishes mechanical and electrical contact with the fixed contact, and an open position P₁, wherein the movable and fixed contacts are maximally spaced apart, with a stroke having a movement region where the movable and fixed contacts are spaced apart, and a contact region, where a conductive surface of the movable contact is applied against a conductive surface of the fixed contact, the electric motor configured to drive a mechanism with a reduction coefficient that varies as a function of position, with a reduction coefficient C_{I} at an interface between a movement region and a contact region of the movable and fixed contacts, the reduction coefficient C_{I} being lower than reduction coefficients C_{I1} and C_{I2} at ends of the movement region and the contact region.

2. The motorized contactor of claim 1, wherein the electric motor is connected to the carriage supporting the movable contact by a direct push-pull drive means.

3. The motorized contactor of claim 1, wherein the movable contact comprises an end of an electrically conductive flexible busbar.

4. The motorized contactor of claim 3, wherein the movable contact is moved by way of a carriage with rotary movement, the carriage being connected at one end to the movable contact and being articulated with respect to a pivot located at another end of the carriage, the electrically conductive flexible busbar having a second end attached to a housing of the motorized contactor, to form an electrical connection terminal, and wherein the position-dependent reduction coefficient mechanism is coupled to the carriage.

5. The motorized contactor of claim 1, wherein the movable contact is moved by way of a carriage driven by a connecting rod.

6. The motorized contactor of claim 5, wherein the connecting rod is fixed with one rotational degree of freedom, so as to provide a variable reduction ratio between the electric motor and the carriage.

7. The motorized contactor of claim 1, wherein the movable contact supports a conductive pad cooperating with a conductive pad supported by the fixed contact.

8. The motorized contactor of claim 1, wherein the movable contact includes two tongues respectively supporting a conductive pad and a sacrificial pad.

9. The motorized contactor of claim 1, further comprising an electronic circuit for controlling the electric motor.

10. The motorized contactor of claim 1, wherein the movement region is extended by a parking region.

11. The motorized contactor of claim 1, wherein the contact region includes a parking region.

12. The motorized contactor of claim 1, wherein the mechanism with a variable reduction coefficient is produced by way of a movement reducer, a last movable part of which is provided with a cam, the cam cooperating with a direct drive means integral with the carriage.

13. The motorized contactor of claim 12, wherein the cam has two cam profiles, the cam profile cooperating with a leg of the direct drive means to mobilize the carriage in one direction of rotation of the movable part, the cam profile cooperating with a second leg of the direct drive means to mobilize the carriage in the other direction of rotation of the movable part.

14. The motorized contactor of claim 13, wherein the cam and each of the legs have complementary means for ensuring a stop delimiting travel of the movable part in each direction of rotation.

15. The motorized contactor of claim 9, wherein the electronic circuit comprises a position sensor configured to measure a position of the carriage.

16. The motorized contactor of claim 15, wherein the position sensor is a two-state sensor consisting of two flexible, electrically conductive blades and means for measuring electrical resistance between the blades located on the electronic circuit, switching between two states being discriminated by measuring the electrical resistance between the blades and being obtained for a given relative position between the carriage and the electronic circuit.

17. A mechatronic electrical connection assembly comprising a housing containing a motorized contactor according to claim 1.

18. The mechatronic electrical connection assembly of claim 17, wherein the housing contains a second motorized contactor according to claim 1, the housing comprising an electronic board configured to control the two motorized contactors.

19. The mechatronic electrical connection assembly of claim 17, wherein the housing comprises a second fixed contact and a second movable contact mobilized by the electric motor.
